(19) United States
(12) Patent Application Publication
(10) Pub. No.: US 2025/0106370 A1
(43) Pub. Date: Mar. 27, 2025

(54) Systems and Methods for Artificial Intelligence (AI)-Driven 2D-to-3D Video Stream Conversion

(71) Applicants: Sony Interactive Entertainment LLC, San Mateo, CA (US); Sony Interactive Entertainment Inc., Tokyo (JP)

(72) Inventors: Yuanhan Chen, San Mateo, CA (US); Ensha Neron, San Mateo, CA (US); Brittni Snoke, San Mateo, CA (US); Mehak Bhat, San Mateo, CA (US)

(21) Appl. No.: 18/475,108

(22) Filed: Sep. 26, 2023

(51) Int. Cl. H04N 13/139; H04N 13/161; H04N 13/194; H04N 21/2187; H04N 21/81

(52) U.S. Cl. CPC H04N 13/139; H04N 13/161; H04N 13/194; H04N 21/2187; H04N 21/816

(57) ABSTRACT

A system is disclosed for three-dimensional (3D) conversion of a video stream. The system includes an input processor configured to receive an input video stream that includes a first series of video frames. The system also includes a 3D virtual model generator configured to select video frames from the input video stream and generate a 3D virtual model for content depicted in the selected video frames. The system also includes a frame generator configured to generate a second series of video frames for an output video stream depicting content within the 3D virtual model at a specified frame rate. The system also includes an output processor configured to encode and transmit the output video stream to a client computing system.

### BACKGROUND OF THE INVENTION

The video game industry has seen many changes over the years and has been trying to find ways to enhance the video game play experience for players and increase player engagement with the video games and/or online gaming systems. Additionally, the video game industry has sought improvements in technology associated with video game spectating in which spectators view video game play by others through online video streaming. When a person (player or spectator) increases their engagement with a video game, the person is more likely to increase their playing and/or spectating of the video game, which ultimately leads to increased revenue for the video game developers and providers and the video game industry in general. Therefore, video game developers and providers continue to seek improvements in video game online streaming operations, particularly with regard to how spectators of video game play can become more engaged with the video stream content that they receive and consume. It is within this context that implementations of the present disclosure arise.

### SUMMARY OF THE INVENTION

In an example embodiment, a system for three-dimensional (3D) conversion of a video stream is disclosed. The system includes an input processor configured to receive an input video stream including a first series of video frames. The system also includes a 3D virtual model generator configured to select video frames from the input video stream and generate a 3D virtual model for content depicted in the selected video frames. The system also includes a frame generator configured to generate a second series of video frames for an output video stream depicting content within the 3D virtual model at a specified frame rate. The system also includes an output processor configured to encode and transmit the output video stream to a client computing system.

In an example embodiment, a method is disclosed for 3D conversion of a video stream. The method includes receiving an input video stream including a first series of video frames. The method also includes selecting a set of video frames from the first series of video frames. The method also includes generating a 3D virtual model for content depicted in the set of video frames selected from the first series of video frames. The method also includes generating video frames for an output video stream depicting content within the 3D virtual model at a specified frame rate. The method also includes encoding and transmitting the output video stream to a client computing system.

### BRIEF DESCRIPTION OF THE DRAWINGS

FIG. 1 shows a system for converting a two-dimensional (2D) video stream into a 3D video stream, in accordance with some embodiments.

FIG. 2 shows an example of the frame selection engine operating in an example rules-based manner to obtain a subset of selected video frames from the 2D video stream, where the subset of selected video frames includes video frames that correspond to a specified time frequency of occurrence within the series of video frames within the 2D video stream, in accordance with some embodiments.

FIG. 3 shows an example of the frame selection engine operating in a dynamic manner to obtain the subset of selected video frames from the 2D video stream, where the subset of selected video frames is based on an amount of visual change depicted in the 2D video stream as a function of time, in accordance with some embodiments.

FIG. 4 shows an example of the NeRF engine operating to generate temporal instances of the 3D virtual model for each of the 2D frame images in the subset of selected frames that were selected by the frame selection engine, in accordance with some embodiments.

FIG. 5 shows an example of the NeRF engine operating to interpolate 3D virtual model temporal instances for frame sequence times between each of the temporally neighboring 3D virtual model temporal instances in the base set of 3D virtual model temporal instances to achieve a complete set of 3D virtual model temporal instances that temporally correspond to a specified frame rate of the output 3D video stream, in accordance with some embodiments.

FIG. 6 shows an example of the frame generator operating to render 3D frame images for the 3D video stream from the complete set of 3D virtual model temporal instances generated by the 3D virtual model generator, in accordance with some embodiments.

FIG. 7 shows an example of the use case depicted in FIG. 1, in which a spectator is using the system to view a live stream of the video game player playing the video game, as captured by the camera, in accordance with some embodiments.

FIG. 8 shows an example of a display of the computing system of the video game player, in accordance with some embodiments.

FIG. 9 shows an example of the system implemented for the use case of live stream of a sporting event, in accordance with some embodiments.

FIG. 10 shows a flowchart of a method for 3D conversion of a video stream, in accordance with some embodiments.

FIG. 11 shows various components of an example server device within a cloud-based computing system that can be used to perform aspects of the system and associated methods for 3D conversion of a 2D video stream as disclosed herein, in accordance with some embodiments.

### DETAILED DESCRIPTION OF THE INVENTION

In the following description, numerous specific details are set forth in order to provide a thorough understanding of the present disclosure. It will be apparent, however, to one skilled in the art that embodiments of the present disclosure may be practiced without some or all of these specific details. In other instances, well known process operations have not been described in detail in order not to unnecessarily obscure the present disclosure.

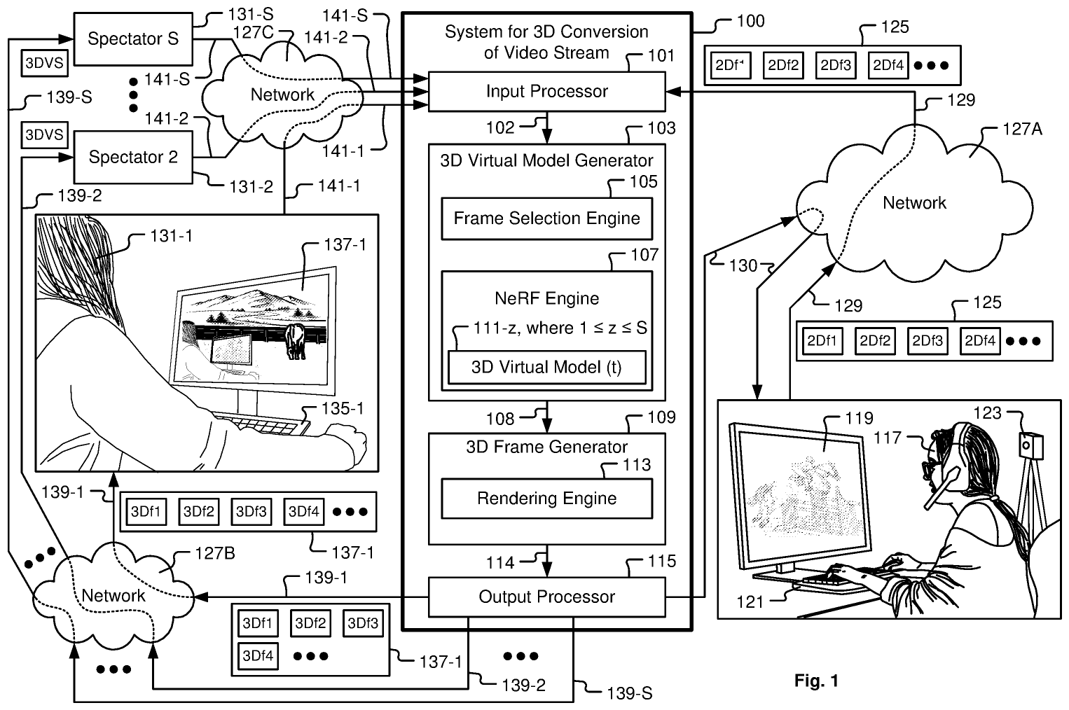

FIG. 1 shows a system 100 for converting a two-dimensional (2D) video stream 125 into a three-dimensional (3D) video stream 137-z, where z is any integer in a range from 1 to S that specifies a particular spectator 131-z to whom the 3D video stream 137-z is transmitted by the system 100, in accordance with some embodiments. In various embodiments, artificial intelligence (AI) machine learning technology known as Neural Radiance Fields (NeRFs) is implemented in a NeRF engine 107 to generate a 3D virtual model 111-z including representations of subject matter, e.g., scenes, objects, persons, events, etc., from at least a subset of 2D frame images 2Df1, 2Df2, 2Df3, etc., that comprise the 2D video stream 125, so as to enable rendering of 3D frame images 3Df1, 3Df2, 3Df3, etc., from the 3D virtual model 111-z to create the 3D video stream 137-z for the z^{th} spectator 131-z. The various systems and methods disclosed herein leverage neural networks within the NeRF engine 107 to “learn” the underlying 3D structure, appearance, and content of the subject matter depicted in the 2D video frames 2Df1, 2Df2, 2Df3, etc., of the 2D video stream 125. The NeRF-based process of generating the 3D virtual model 111-z includes operating the NeRF engine 107 to analyze the subset of the 2D frame images 2Df1, 2Df2, 2Df3, etc., selected from the 2D video stream 125 to capture elements such as lighting conditions, points-of-view, spatial relationships between objects, and movements of objects that are depicted in the 2D video stream 125. Using this information, the NeRF engine 107 infers the underlying 3D geometry and appearance information from the 2D video stream 125, which enables creation of the dynamic (temporally varying) 3D virtual model 111-z that corresponds to the dynamic (temporally varying) 2D video stream 125.

It should be understood that the NeRF engine 107 is implemented herein to generate the 3D virtual model 111-z that is rendered into a temporally controlled sequence of 3D frame images 3Df1, 3Df2, 3Df3, etc., to generate the 3D video stream 137-z, as opposed to generating just a static 3D image. In some embodiments, the 2D video stream 125 includes a sequence of 2D frame images 2Df1, 2Df2, 2Df3, etc., of some subject matter from various different lighting angles, points-of-view, positions, etc. For example, in the context of a rock concert, the 2D video stream 125 includes multiple 2D frame images 2Df1, 2Df2, 2Df3, etc., taken from various positions within the venue. These 2D frame images 2Df1, 2Df2, 2Df3, etc., of the 2D video stream 125 serve as input to the AI model implemented within the NeRF engine 107. The NeRF engine 107 is configured and used to create the 3D virtual model 111-z of the subject matter depicted in the 2D video stream 125.

The 3D virtual model 111-z that is generated by the NeRF engine 107 is a coherent and immersive virtual space. The 3D virtual model 111-z can be manipulated, modified, and/or augmented in accordance with essentially any user-specified parametric input. In this manner, a user is able to insert subject matter into the 3D virtual model 111-z that was not present in the 2D video stream 125, and/or omit subject matter from the 3D virtual model 111-z that was present in the 2D video stream 125. For example, in some embodiments, an image of the user is added to the 3D virtual model 111-z, as if the user is teleported into the subject matter of the 2D video stream 125.

The NeRF-based 2D-to-3D video stream conversion process disclosed herein enables shared virtual experiences among multiple users. For example, in some embodiments, multiple users can simultaneously enter the NeRF-generated 3D virtual model 111-z, which allows for friends and/or participants to virtually engage with each other in context of the 3D virtual model 111-z. For example, if the 2D video stream 125 is of a live event, then multiple users who may or may not be present at the live event can be included in the corresponding 3D virtual model 111-z of the live event that is generated by the NeRF engine 107, such that the multiple users appear in the resulting 3D video stream 137-z of the live event. This collaborative aspect of the NeRF-based 2D-to-3D video stream conversion process creates a social dimension within the immersive experience of the 3D virtual model 111-z, which fosters interaction and engagement among users and/or spectators.

In some embodiments, multiple users (images of multiple users) are added to the same 3D virtual model 111-z, as if the multiple users are teleported together into the same subject matter of the 2D video stream 125. For example, if the 2D video stream 125 is of a music concert, the 3D virtual model 111-z is generated for the music concert. Then, one or more users can be virtually added into the 3D virtual model 111-z of the music concert, as if they were all actually present at the same music concert. In this manner, the 3D virtual model 111-z that is generated by the NeRF engine 107 can be experienced by any number of users who are virtually transported into whatever context is represented in the 3D virtual model 111-z. It should be understood that the NeRF-generated 3D virtual model 111-z provides a dynamic and interactive environment in which users can explore, interact with virtual objects, and observe the scene from different perspectives.

Once the 3D virtual model 111-z for the z^{th} spectator 131-z corresponding to the 2D video stream 125 is generated by the NeRF engine 107, 3D frame images 3Df1, 3Df2, 3Df3, etc., are rendered from the 3D virtual model 111-z at a specified temporal frequency to create the 3D video stream 137-z for the z^{th} spectator. In some embodiments, the temporal frequency of the video frames 3Df1, 3Df2, 3Df3, etc., in the 3D video stream 137-z is substantially equal to the temporal frequency of the video frames 2Df1, 2Df2, 2Df3, etc., in the 2D video stream 125. In some embodiments, the temporal frequency of both the video frames 2Df1, 2Df2, 2Df3, etc., in the 2D video stream 125 and the video frames 3Df1, 3Df2, 3Df3, etc., in the 3D video stream 137-z is 60 frames per second. However, in various embodiments, the 3D video stream 137-z can be generated to have essentially any temporal frequency of video frames 3Df1, 3Df2, 3Df3, etc., which may or may not match the temporal frequency of video frames 2Df1, 2Df2, 2Df3, etc., in the 2D video stream 125.

In some embodiments, audio is added to the 3D video stream 137-z. For example, to enhance the realism of the NeRF-generated 3D virtual model 111-z of a live event that is captured in the 2D video stream 125, audio recordings of the live event can be integrated with the 3D virtual model 111-z, such that the sounds in the audio recordings align with the actions that are occurring in the 3D virtual model 111-z from which the 3D video stream 137-z is rendered. In some embodiments, the audio that is integrated into the 3D virtual model 111-z is substantially equivalent to the audio associated with the 2D video stream 125. In some embodiments, the audio that is integrated into the 3D virtual model 111-z is a modified version of the audio associated with the 2D video stream 125. In some embodiments, audio received from one or more users is added to the audio associated with the 2D video stream 125 to create the audio that is integrated into the 3D virtual model 111-z. In some embodiments, AI is used to generate audio for the 3D virtual model 111-z, particularly for subject matter that is added to the 3D virtual model 111-z that was not present in the original 2D video stream 125. In some embodiments, the 3D virtual model 111-z that is created from the 2D video stream 125 is dynamically modified to coordinate with the audio, e.g., music, sounds, speech, etc., associated with the 3D video stream 137-z.

Using the NeRF engine 107 to generate the 3D virtual model 111-z from the 2D video stream 125 offers many exciting opportunities for creative enhancement and/or customization of the content depicted in the 2D video stream 125. For example, if the 2D video stream 124 is of a concert, the players/performers in the concert that are captured in the 2D image frames 2Df1, 2Df2, 2Df3, etc., that form the 2D video stream 125 can be visually modified, e.g., re-skinned, in the 3D virtual model 111-z. For example, in the concert use case, the visual modification can be done in the 3D virtual model 111-z to change a classic rock performer in the 2D video stream 125 into a Korean Pop performer in the 3D virtual model 111-z, such that the classic rock performer appears as the Korean Pop performer in the 3D video stream 137-z that is rendered from the 3D virtual model 111-z. It should be understood that this is just one of an infinite number of examples and applications by which any subject matter captured in the 2D video stream 125 can be modified per user specifications and preferences in the 3D virtual model 111-z for ultimate rendering in the 3D video stream 137-z that is transmitted to the z^{th} spectator 131-z. It should be appreciated that the customization capabilities afforded by the NeRF-generated 3D virtual model 111-z enable users to personalize their experiences and tailor the 3D virtual model 111-z and the 3D video stream 137-z rendered therefrom to their individual preferences.

By leveraging NeRF technology and advanced machine learning techniques, it is possible to generate highly detailed and immersive 3D virtual models 111-z from 2D frame images 2Df1, 2Df2, 2Df3, etc., of the 2D video stream 125. Generation of the NeRF-based 3D virtual models 111-z opens up new possibilities for virtual experiences, social interactions, and creative expression within virtual environments, offering users a remarkable level of realism and customization.

With reference to FIG. 1, the system 100 includes an input processor 101 configured to receive the input 2D video stream 125 that includes the series of video frames 2Df1, 2Df2, 2Df3, etc., as indicated by arrow 129. In some embodiments, the 2D video stream 125 is captured by a camera 123 operating a location that is remote (physically distant) from the system 100. In some embodiments, the 2D video stream 125 is transmitted from the remote location through a network 127A to the input processor 101 of the system 100, as indicated by arrow 129. In various embodiments, the network 127A can be one or more of a local area network (wired and/or wireless and/or optical), a wide area network (wired and/or wireless and/or optical), a cellular network, a satellite network, and the Internet, among essentially any other type of network over which data signals can be transmitted. In various embodiments, the 2D video stream 125 is conveyed in data packets that are prepared in accordance with any known and available network communication protocol.

FIG. 1 shows an example use case in which the camera 123 is positioned at the remote location to capture video of a video game player 117 playing a video game 119 at a client computing system 121. In some embodiments of this example use case, the 2D video stream 125 can be a live stream of the video game player 117 playing the video game 119 provided through an online live streaming service. It should be understood that the video game live streaming example use case is just one of an effectively infinite number of use cases in which the 2D video stream 125 can be generated. For example, other use cases in which the 2D video stream 125 can be generated by way of the camera 123 include sporting events, concerts, live performances, live events, live gatherings, among others. Also, in some embodiments, the 2D video stream 125 can be of an event that has already occurred, i.e., that is not live. Regardless of the source, subject matter content, and/or live status of the content depicted within the 2D video stream 125, it should be understood that the 2D video stream 125 is comprised of the temporally controlled sequence of 2D frame images 2Df1, 2Df2, 2Df3, etc. In some embodiments, the temporally controlled sequence of 2D frame images 2Df1, 2Df2, 2Df3, etc., occur at a rate of 60 frames per second in the 2D video stream 125. However, it should be understood that in other embodiments the frame rate of the 2D video stream 125 can be either more or less than 60 frames per second, as needed.

The system 100 also includes a 3D virtual model generator 103 that is connected to receive the incoming 2D video stream 125 from the input processor 101, as indicated by arrow 102. The 3D virtual model generator 103 is configured to select video frames from the series of video frames 2Df1, 2Df2, 2Df3, etc., within the 2D video stream 125. The 3D virtual model generator 103 is also configured to generate the 3D virtual model 111-z for content depicted in the video frames that are selected from the 2D video stream 125. In some embodiments, the 3D virtual model generator 103 includes a frame selection engine 105 that is configured to select the video frames for 3D conversion from the series of video frames 2Df1, 2Df2, 2Df3, etc., within the 2D video stream 125. In some embodiments, the frame selection engine 105 is configured to operate in a rules-based manner, such that video frames are selected from the series of video frames 2Df1, 2Df2, 2Df3, etc., within the 2D video stream 125 in accordance with one or more specified rules. For example, in some embodiments, the frame selection engine 105 is configured to select video frames from the series of video frames 2Df1, 2Df2, 2Df3, etc., within the 2D video stream 125 in accordance with a fixed temporally frequency. In some embodiments, the video frames selected by the frame selection engine 105 from the series of video frames 2Df1, 2Df2, 2Df3, etc., within the 2D video stream 125 is a subset (less than all) of the series of video frames 2Df1, 2Df2, 2Df3, etc., within the 2D video stream 125.

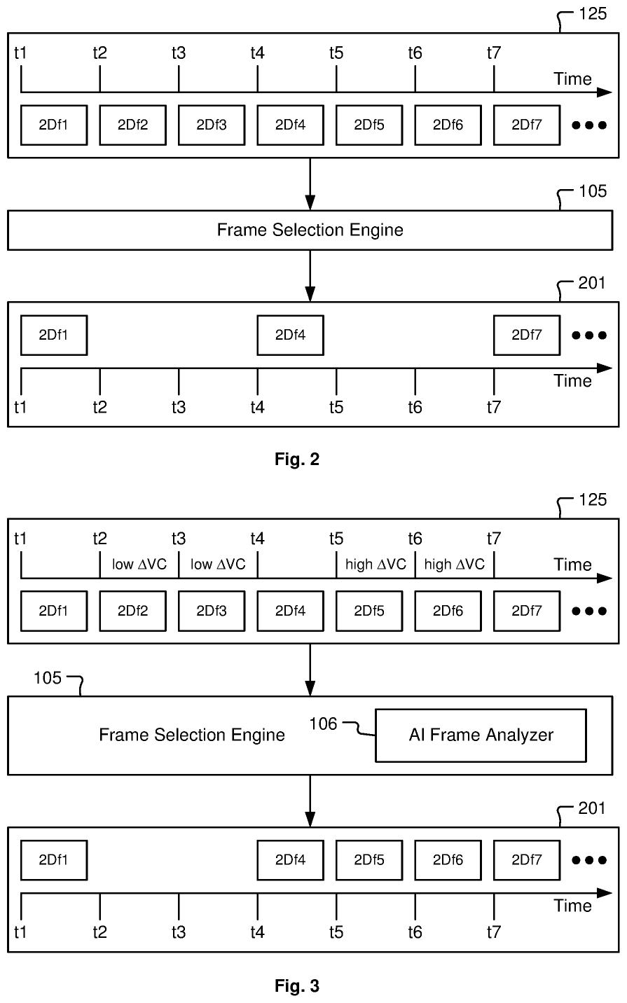

FIG. 2 shows an example of the frame selection engine 105 operating in an example rules-based manner to obtain a subset of selected video frames 201 from the 2D video stream 125, where the subset of selected video frames 201 includes video frames that correspond to a specified time frequency of occurrence within the series of video frames 2Df1, 2Df2, 2Df3, etc., within the 2D video stream 125, in accordance with some embodiments. More specifically, the particular example of FIG. 2 shows the frame selection engine 105 operating in an example rules-based manner to select every third video frame 2Df1, 2Df4, 2Df7, and so on, from the series of video frames 2Df1, 2Df2, 2Df3, etc., within the 2D video stream 125 for subsequent use as inputs to generate various states of the 3D virtual model 111-z corresponding to various times. In particular, FIG. 2 shows an example of frame selection in which two frames in the 2D video stream 125 are skipped between each frame that is selected for inclusion in the subset of selected frames 201. Therefore, in the example of FIG. 2, the subset of selected frames 201 includes frame 2Df1 occurring at time t1, frame 2Df4 occurring at time t4, frame 2Df7 occurring at time t7, and so on. It should be understood that the rules-based frame selection depicted in FIG. 2 is provided by way of example. In various embodiments, essentially any rule or combination of rules can be applied to obtain the subset of selected frames 201 from the series of video frames 2Df1, 2Df2, 2Df3, etc., within the 2D video stream 125.

In some embodiments, the frame selection engine 105 is configured to select video frames from the series of video frames 2Df1, 2Df2, 2Df3, etc., within the 2D video stream 125 in a dynamic manner in accordance with some specified criteria. In some embodiments, the frame selection engine 105 is configured to dynamically adjust selection of video frames from the 2D video stream 125 as a function of time. For example, in some embodiments, the frame selection engine 105 is configured to increase a rate of video frame selection from the series of video frames 2Df1, 2Df2, 2Df3, etc., within the 2D video stream 125 in response to an increase in visual changes depicted within the 2D video stream 125 over a specified period of time. In this manner, the subset of selected frames 201 will include frames that capture substantive changes in the 2D video stream 125 as a function of time over the specified period of time. Then, correspondingly, the 3D virtual model 111-z generated as a function of time over the specified period of time by the 3D virtual model generator 103 will reflect the substantive changes that occurred in the 2D video stream 125 over the specified period of time. Also, in some embodiments, the frame selection engine 105 is configured to decrease the rate of video frame selection from the series of video frames 2Df1, 2Df2, 2Df3, etc., within the 2D video stream 125 in response to a decrease in visual changes depicted within the 2D video stream 125 over a specified period of time. In this manner, the subset of selected frames 201 will most efficiently capture changes that occur in the 2D video stream 125 as a function of time over the specified period of time. Correspondingly, the 3D virtual model generator 103 will generate the 3D virtual model 111-z in a most efficient manner as a function of time over the specified period of time by reducing/minimizing a number of temporally successive instances of the 3D virtual model 111-z that are essentially equivalent.

FIG. 3 shows an example of the frame selection engine 105 operating in a dynamic manner to obtain the subset of selected video frames 201 from the 2D video stream 125, where the subset of selected video frames 201 is based on an amount of visual change depicted in the 2D video stream 125, in accordance with some embodiments. For example, between times t1 and t4 the amount of visual change depicted in the 2D video stream 125 is low (low ΔVC). Therefore, between times t1 and t4, the frame selection engine 105 operates to skip selection of the 2D video frames 2Df2 and 2Df3. Then, between times t4 and t7 the amount of visual change depicted in the 2D video stream 125 is high (high ΔVC). Therefore, between times t4 and t7, the frame selection engine 105 operates to select each of the 2D video frames 2Df4, 2Df5, 2Df6, and 2Df7 for inclusion in the subset of selected frames 201. In some embodiments, the frame selection engine 105 implements an AI frame analyzer 106 to analyze the series of video frames 2Df1, 2Df2, 2Df3, etc., within the 2D video stream 125 as a function of time to identify when the amount of visual change depicted in the 2D video stream 125 has increase above a threshold level that triggers selection of the 2D video frames for inclusion in the subset of selected frames 201. Example threshold levels include visual changes that are reflective of object movement, object appearance, object disappearance, point-of-view movement/change, lighting change, and scene change, among essentially any other visual change within the 2D video stream 125 that should be reflected in the 3D virtual model 111-z generated as a function of time by the 3D virtual model generator 103 to genuinely represent the subject matter content of the 2D video stream 125 as a function of time.

Additionally, in some embodiments, the frame selection engine 105 simultaneously implements both a rules-based approach and a dynamic (optionally AI-assisted) approach to select 2D video frames from the series of video frames 2Df1, 2Df2, 2Df3, etc., within the 2D video stream 125 for inclusion in the subset of selected frames 201. For example, in some embodiments, the frame selection engine 105 operates to select 2D video frames for inclusion in the subset of selected frames 201 based on the amount of visual change within the 2D video stream 125 exceeding the threshold level, while at the same time operating to maintain a minimum temporal frequency at which 2D video frames are selected from the 2D video stream 125 for inclusion in the subset of selected frames 201.

The 3D virtual model generator 103 also includes the NeRF engine 107 configured to implement the NeRF AI model to generate the 3D virtual model 111-z for content depicted in the subset of selected video frames 201, as selected by the frame selection engine 105. In some embodiments, the NeRF AI model implemented within the NeRF engine 107 is a fully-connected neural network that is trained to generate the 3D virtual model 111-z that is representative of subject matter depicted in one or more 2D images. In some embodiments, the NeRF engine 107 processes images that represent a scene from multiple different viewing angles and interpolates between the images to generate one 3D virtual model 111-z of the complete scene. In some embodiments, for a given 2D frame image, the NeRF AI model implemented within the NeRF engine 107 is trained to map directly from viewing direction and spatial location (5D input) to opacity and color (4D output). Information on NeRF technology is provided in the following reference: Mildenhall, Ben, et al. “Nerf: Representing scenes as neural radiance fields for view synthesis.” Communications of the ACM 65.1 (2021): 99-106, which is incorporated herein by reference in its entirety for all purposes.

In some embodiments, the NeRF engine 107 is capable of generating the 3D virtual model 111-z from a single 2D frame image. However, it should be understood that the detail and resolution of the 3D virtual model 111-z is proportional to the number of 2D frame images that are provided as input to the NeRF engine 107. Therefore, selection of more frames for inclusion with the subset of selected frames 201 corresponds to generation of a more detailed/higher resolution 3D virtual model 111-z by the NeRF engine 107. In some embodiments, a standard video livestream frame rate of 60 frames per second offers more than enough 2D frame images from which an adequate subset of selected frames 201 can be selected by the frame selection engine 105 to enable generation of a robust high detail/high-resolution 3D virtual model 111-z by the NeRF engine 107.

It should be understood that because the 2D frame images 2Df1, 2Df2, 2Df3, etc., of the 2D video stream 125 are used as input to the NeRF engine 107 for generation of the 3D virtual model 111-z that will then be used for rendering of the 3D video stream 137-z, the resolution of the 3D video stream 137-z is independent of the resolution of the 2D video stream 125. Therefore, the 2D video stream 125 does not have to be of high resolution. This lowers the bandwidth requirements for transmitting the 2D video stream 125 to the system 100. Additionally, because the NeRF engine 107 is used to generate the 3D virtual model 111-z from the 2D frame images 2Df1, 2Df2, 2Df3, etc., of the 2D video stream 125, and because the 3D video stream 137-z is rendered from the 3D virtual model 111-z, there does not need to be a one-to-one correspondence between the 2D frame images 2Df1, 2Df2, 2Df3, etc., of the 2D video stream 125 and the 3D frame images 3Df1, 3Df2, 3Df3, etc., of the 3D video stream 137-z, which provides for a reduction in the amount of 2D video stream 125 input without incurring a corresponding decrease in quality of the 3D video stream 137-z output.

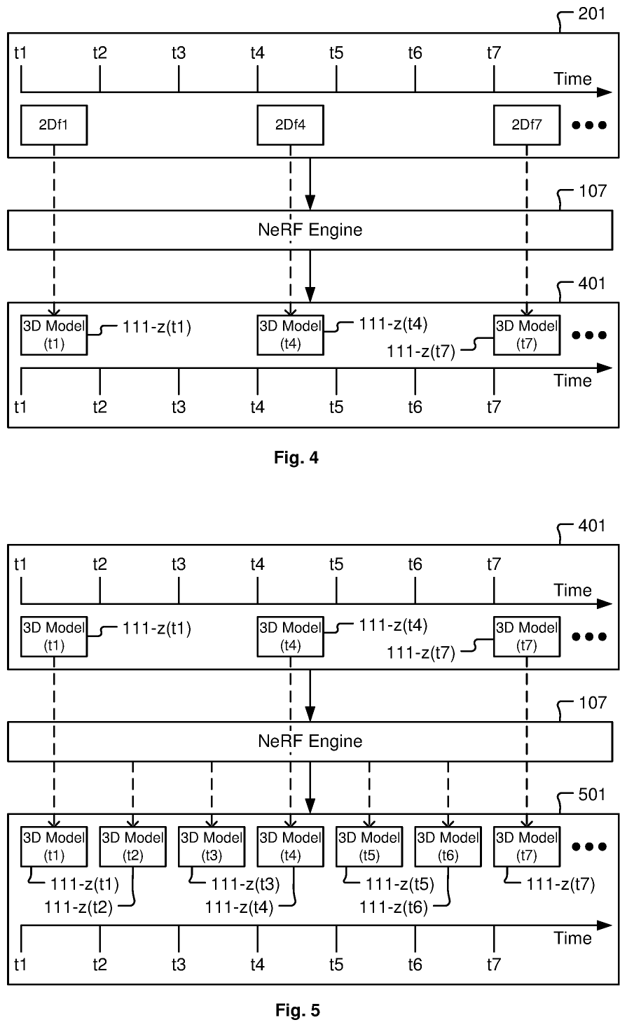

FIG. 4 shows an example of the NeRF engine 107 operating to generate temporal instances of the 3D virtual model 111-z for each of the 2D frame images in the subset of selected frames 201 that were selected by the frame selection engine 105, in accordance with some embodiments. In some embodiments, the NeRF engine 107 of the 3D virtual model generator 103 is configured to generate a base set 401 of 3D virtual model 111-z temporal instances that includes a separate temporal instance of the 3D virtual model 111-z for each of the video frames in the subset of selected frames 201 that were selected by the frame selection engine 105. For example, FIG. 4 shows that a separate temporal instance of the 3D virtual model 111-z is generated at each of times t1, t4, and t7, based on the 2D frame images 2Df1, 2Df4, and 2Df7, respectively, in the subset of selected frames 201.

In some embodiments, the 3D virtual model generator 103 is configured to generate additional temporal instances of the 3D virtual model 111-z to supplement the base set 401 of 3D virtual model 111-z temporal instances so as to achieve a one-to-one correspondence between 3D virtual model 111-z temporal instances and a specified frame rate. In some embodiments, the 3D virtual model generator 103 is configured to implement the NeRF engine 107 to generate the additional temporal instances of the 3D virtual model 111-z. In some embodiments, the NeRF engine 107 is configured to interpolate between temporally neighboring 3D virtual model 111-z temporal instances in the base set 401 of 3D virtual model 111-z temporal instances to generate the additional temporal instances of the 3D virtual model 111-z.

FIG. 5 shows an example of the NeRF engine 107 operating to interpolate 3D virtual model 111-z temporal instances for frame sequence times between each of the temporally neighboring 3D virtual model 111-z temporal instances in the base set 401 of 3D virtual model 111-z temporal instances to achieve a complete set 501 of 3D virtual model 111-z temporal instances that temporally correspond to a specified frame rate of the output 3D video stream 137-z, in accordance with some embodiments. In the example of FIG. 5, the specified frame rate of the output 3D video stream 137-z matches the frame rate of the input 2D video stream 125. In some embodiments, the specified frame rate of the output 3D video stream 137-z is 60 frames per second. However, in various embodiments, the 3D video stream 137-z can be generated to have essentially any temporal frequency of video frames 3Df1, 3Df2, 3Df3, etc., which may or may not match the temporal frequency of video frames 2Df1, 2Df2, 2Df3, etc., in the 2D video stream 125. As shown in FIG. 5, the NeRF engine 107 operates to generate a separate 3D virtual model 111-z temporal instance for each of the frame times t1, t2, t3, t4, etc. More specifically, the 3D virtual model 111-z temporal instances for frame times t1, t4, and t7, etc. are generated by the NeRF engine 107 based on the 2D frame images 2Df1, 2Df4, 2Df7, etc., in the subset of selected frames 201 at frame times t1, t4, and t7, etc., respectively. Also, the 3D virtual model 111-z temporal instances for frame times t2 and t3 are generated by the NeRF engine 107 by interpolating between the temporally neighboring 3D virtual model 111-z temporal instances at frame times t1 and t4. Similarly, the 3D virtual model 111-z temporal instances for frame times t5 and t6 are generated by the NeRF engine 107 by interpolating between the temporally neighboring 3D virtual model 111-z temporal instances at frame times t4 and t7, and so on.

With reference back to FIG. 1, the system 100 also includes a 3D frame generator 109 that is configured to generate the video frames 3Df1, 3Df2, 3Df3, etc., for the output 3D video stream 137-z depicting content within the 3D virtual model 111-z at the specified frame rate of the 3D video stream 137-z. The 3D frame generator 109 receives as input the complete set 501 of 3D virtual model 111-z temporal instances generated by the 3D virtual model generator 103, as indicated by arrow 108. In some embodiments, the 3D frame generator 109 is configured to implement a rendering engine 113 that is configured to generate a 2D projection image of the 3D virtual model 111-z from a specified viewpoint within the 3D virtual model 111-z.

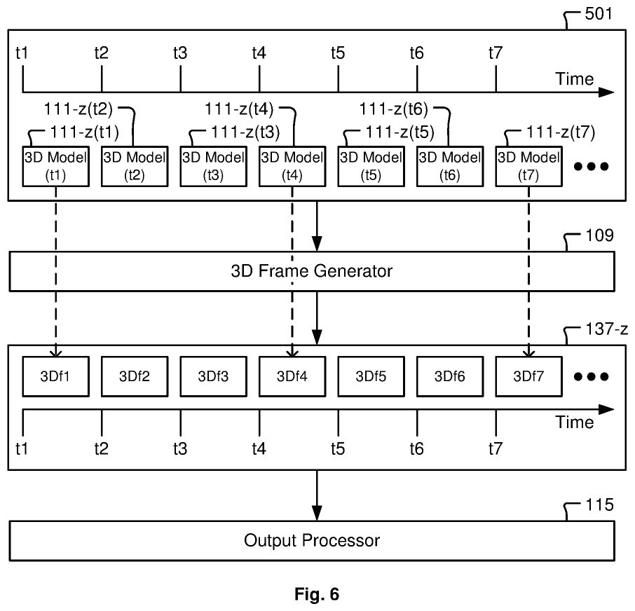

FIG. 6 shows an example of the frame generator 109 operating to render 3D frame images 3Df1, 3Df2, 3Df3, etc., for the 3D video stream 137-z from the complete set 501 of 3D virtual model 111-z temporal instances generated by the 3D virtual model generator 103, in accordance with some embodiments. Specifically, the rendering engine 113 generates a separate projection image from a specified viewpoint within each of the 3D virtual model 111-z temporal instances (3D Model (t1), 3D Model (t2), 3D Model (t3), etc.) to create the respective 3D frame images 3Df1, 3Df2, 3Df3, etc., in the 3D video stream 137-z, which is conveyed to an output processor 115, as indicated by arrow 114.

The output processor 115 is configured to receive the 3D video stream 137-z as composed by the 3D frame generator 109, and deliver the 3D video stream 137-z to the client system 135-z of the z^{th} spectator 131-z by way of a network 127B, as indicated by arrow 139-z. The output processor 115 is configured to encode and transmit the output 3D video stream 137-z to the client system 135-z of the spectator 131-z. In some embodiments, the output processor 115 is defined to prepare and transmit the communication to the client system 135-z of the spectator 131-z within data packets over the network 127B, where the network 127B is one or more of a local area network (wired and/or wireless and/or optical), a wide area network (wired and/or wireless and/or optical), a cellular network, a satellite network, and the Internet, among essentially any other type of network over which data signals can be transmitted. In these embodiments, the data packets are prepared by the output processor 115 in accordance with any known and available network communication protocol. In some embodiments, the output processor 115 includes a network interface card (NIC) to provide for packetization of outgoing data to be transmitted from the system 100 to the client system 135-z of the spectator 131-z.

In some embodiments, the specified viewpoint with the 3D virtual model 111-z that is used by the rendering engine 113 to generate the 3D frame images is a default viewpoint. In some embodiments, the default viewpoint is determined to correspond with a viewpoint from which the 2D frame images 2Df1, 2Df2, 2Df3, etc., are taken in the input 2D video stream 125. However, in some embodiments, the specified viewpoint with the 3D virtual model that is used by the rendering engine 113 to generate the 3D frame images 3Df1, 3Df2, 3Df3, etc., is specified by the particular spectator 131-z to whom the 3D video stream 137-z is transmitted. For example, the z^{th} spectator 131-z communicates their preferred viewpoint for their particular version of the output 3D video stream 137-z to the input processor 101 of the system 100 by way of a network 127C, as indicated by arrow 141-1. In some embodiments, the client system 135-z of the z^{th} spectator 131-z is defined to prepare and transmit data specifying the preferred viewpoint of the spectator 131-z within data packets over the network 127C, wherein the network 127C is one or more of a local area network (wired and/or wireless and/or optical), a wide area network (wired and/or wireless and/or optical), a cellular network, a satellite network, and the Internet, among essentially any other type of network over which data signals can be transmitted. In these embodiments, the data packets are prepared by the client system 135-z in accordance with any known and available network communication protocol. In some embodiments, the client system 135-z includes a NIC to provide for packetization of outgoing data to be transmitted from the client system 135-z to the system 100. As the 3D video stream 137-z is received at the client computing system 135-z of the spectator 131-z, the 3D video stream 137-z is decoded as needed and displayed on the client computing system 135-z. In some embodiments, the output processor 115 is configured to encode and transmit the incoming 2D video stream 125 to the client system 135-z of the spectator 131-z in conjunction with the output 3D video stream 137-z. In this manner, the spectator 131-z is able to see the differences between the original 2D video stream 125 and their particular version of the output 3D video stream 137-z.

The input processor 101 is configured to receive the specified viewpoint from the client system 135-z of the z^{th} spectator 131-z and provide the specified viewpoint to the 3D frame generator 109. The 3D frame generator 109 then uses the viewpoint specified by the z^{th} spectator 131-z to generate the 3D frame images 3Df1, 3Df2, 3Df3, etc., for the particular output 3D video stream 137-z that is to be transmitted to the spectator 131-z. In this manner, each of the spectators 131-1 to 131-S, where S is any non-zero integer number, is able to independently control the point-of-view with the 3D virtual model 111-z from which their particular output 3D video stream 137-z is generated. Also, it should be understood that the point-of-view specified by any one or more of the spectators 131-1 to 131-S can be different from the point-of-view depicted in the input 2D video stream 125. Therefore, it should be understood and appreciated that the system 100 provides a remarkable enhancement to how the subject matter of the input 2D video stream 125 can be viewed and engaged with by the spectators 131-1 to 131-S.

In some embodiments, the system 100 is configured to receive a customization option specification from the client system 135-z of the spectator 131-z, by way of the network 127C and input processor 101, as indicated by arrow 141-z. The system 100 is configured to provide the received customization option specification to the 3D virtual model generator 103. The 3D virtual model generator 103 is configured to apply the customization option specification in generating the 3D virtual model 111-z that will be used by the 3D frame generator 109 to generate the particular output 3D video stream 137-z for the particular spectator 131-z. In various embodiments, the customization option specification includes one or more of a background specification, a lighting specification, a contrast specification, a color specification, a subject matter theme specification, a contextual theme specification, an environmental specification, a special effect specification, a motion specification, an object specification, an object skin specification, an entity skin specification, and/or an in-game cosmetic specification. It should be understood that the system 100 operates to generate a different 3D virtual model 111-z for each spectator 131-1 to 131-S. In this manner, each spectator 131-1 to 131-S has independent control over how their 3D video stream 137-1 to 137-S, respectively, is generated. In this manner, each spectator 131-1 to 131-S is able to specify their own field-of-view and their own customization options within their own 3D virtual model 111-z (based on the same input 2D video stream 125) that is used by the 3D frame generator 109 to generate their particular output 3D video stream 137-1 to 137-S, respectively.

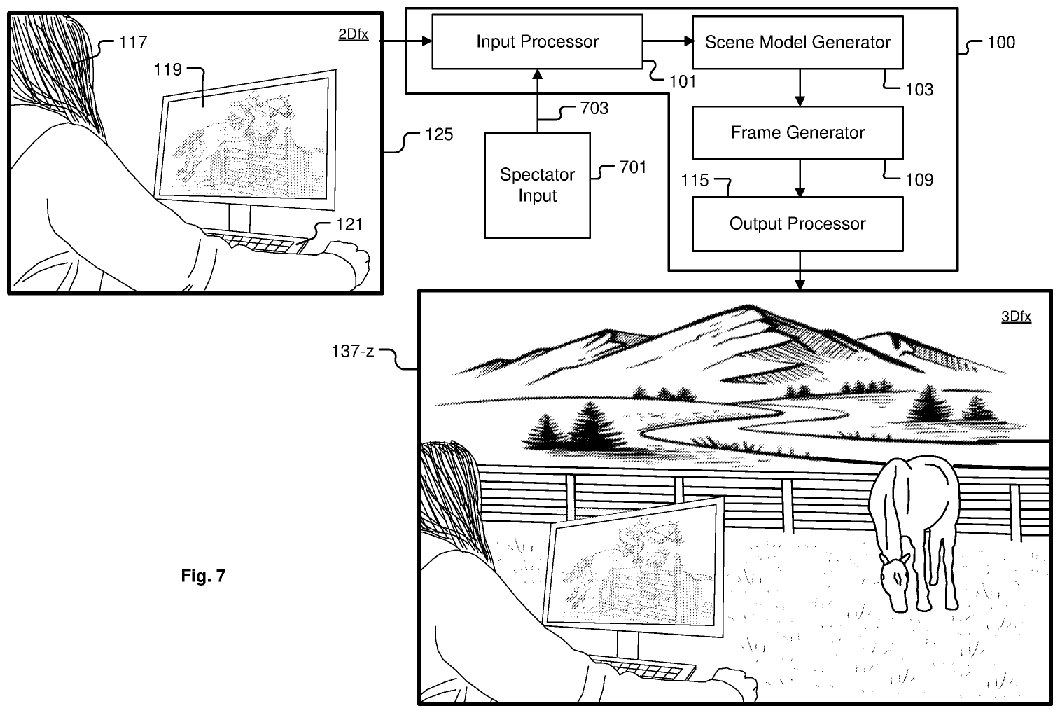

FIG. 7 shows an example of the use case depicted in FIG. 1, in which a spectator 131-z is using the system 100 to view a live stream of the video game player 117 playing the video game 119, as captured by the camera 123, in accordance with some embodiments. In particular, FIG. 7 shows an example 2D video frame 2Dfx that is part of the incoming 2D video stream 125. In this example, the spectator 131-z provides spectator input 701 to the input processor 101 of the system 100, as indicated by arrow 703. In this example, the spectator input 701 includes a spectator-specific field-of-view specification, as well as customization options that request generation of a customized background scene by the system 100. Specifically, the spectator 131-z has requested that the background scene for their particular output 3D video stream 137-z include “a horse grazing in a pasture with mountains and a stream in the distance.” The 3D virtual model generator 103 of the system 100 operates to fulfill the customization requests of the spectator 131-z by engaging the NeRF engine 107 to generate their requested background scene as part of the 3D virtual model 111-z that is used by the 3D frame generator to render the 3D frame images 3Df1, 3Df2, 3Df3, etc., for their particular output 3D video stream 137-z.

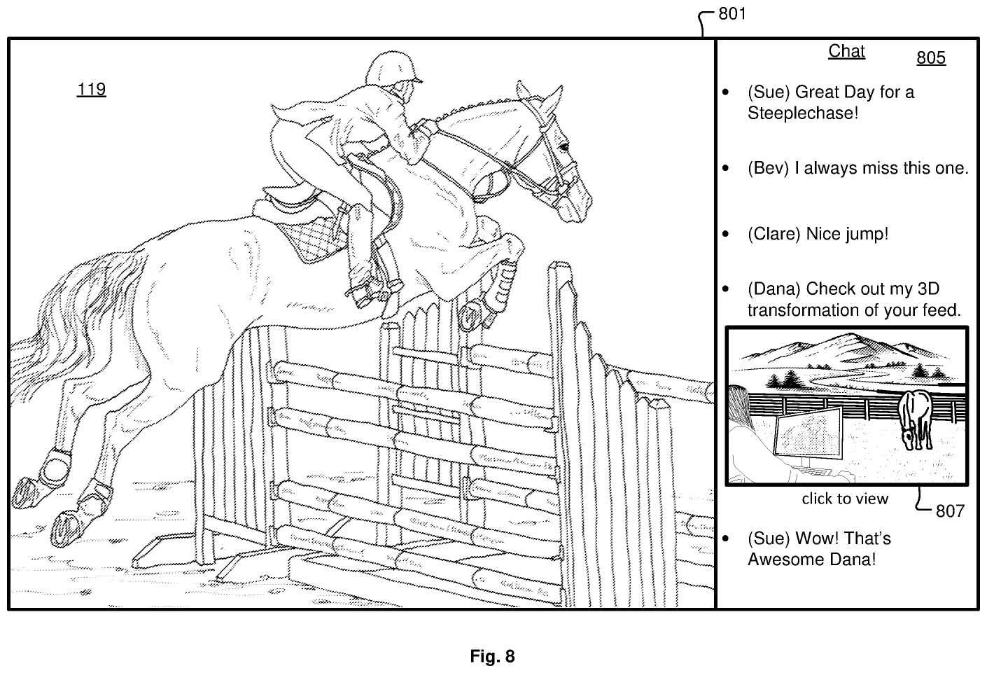

In some embodiments, the input processor 101 is configured to receive commentary from the client system 135-z of the spectator 131-z. Also, in these embodiments, the output processor 115 is configured to convey the received commentary to a source of the input 2D video stream 125, as indicated by arrow 130. In this manner, the spectator 131-z is able to communicate with the video game player 117. FIG. 8 shows an example of a display 801 of the computing system 121 of the video game player 117, in accordance with some embodiments. The display 801 shows the video game 119 that is being played by the video game player 117. The display 801 also shows a chat window 805 is which other interested parties (other players and/or spectators) are able to post messages that can be viewed by the video game player 117 and each other. Because the system 100 enables receipt and conveyance of commentary from the spectators 131-1 to 131-S to the source of the input 2D video stream 125 (to the video game player 117), the system 100 facilitates posting of content in the chat window 805 of the video game player 117. In some embodiments, the posting of content in the chat window 805 of the video game player 117 by the spectator 131-z is a text and/or emoji message. Also, in some embodiments, the spectator 131-z is able to record a video clip 807 of their particular 3D video stream 137-z that is based on the 2D video stream 125 supplied by the video game player 117, and post the video clip 807 to the chat window 805, by way of the system 100. In this manner, the video game player 117 is able to see how the spectator 131-z has used the system 100 to customize the 2D video stream 125 that the video game player 117 live streamed through their camera 123. This form of interactive feedback provides for improved video game player and spectator engagement with the video game platform.

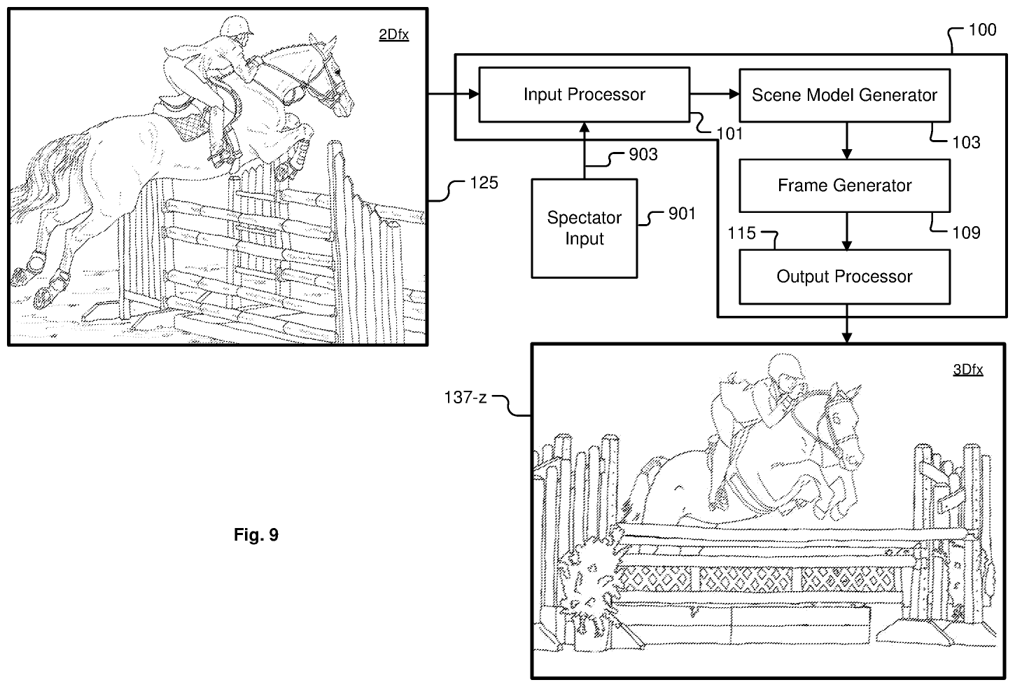

While the examples of FIGS. 1, 7, and 8 concern example use cases of live streaming of online video game play, it should be understood that the system 100 is not limited to that particular type of use case. The system 100 can be implemented in essentially any use case in which a 2D video stream is captured and provided as the input 2D video stream 125 to the system 100. For example, the system 100 can be implemented for live streaming of essentially any live event, such as sporting events, concerts, live performances, live events, live gatherings, etc. FIG. 9 shows an example of the system 100 implemented for the use case of live stream of a sporting event, in accordance with some embodiments. In the example of FIG. 9, the input 2D video stream 125 that is provided to the system 100 is of an equestrian steeplechase event. The input 2D video stream 125 can be captured and transmitted to the system 100 by essentially any type of electronic device that includes a video camera and a network communication capability, e.g., a cell phone or the like. A spectator 131-z that is connected to the system 100 to receive the corresponding output 3D video stream 137-z provides their spectator input 901 to the system 100, as indicated by arrow 903. In this particular example, the spectator input 901 specifies that the spectator 131-z wants to view the event from a different point-of-view that is down-course from the big jump, as compared to the point-of-view shown in the input 2D video stream 125, which is up-course from the big jump. In this example, because the system 100 has generated the 3D virtual model 111-z for the spectator 131-z based on the input 2D video stream 125 and based on the spectator's input 901, the system 100 is able to fulfill the spectator's point-of-view change request, which is shown in the example frame 3Dfx of the output 3D video stream 137-z that is conveyed to the particular spectator 131-z. It should be appreciated that the system 100 enables dynamic viewing possibilities that are not otherwise available with standard live streaming.

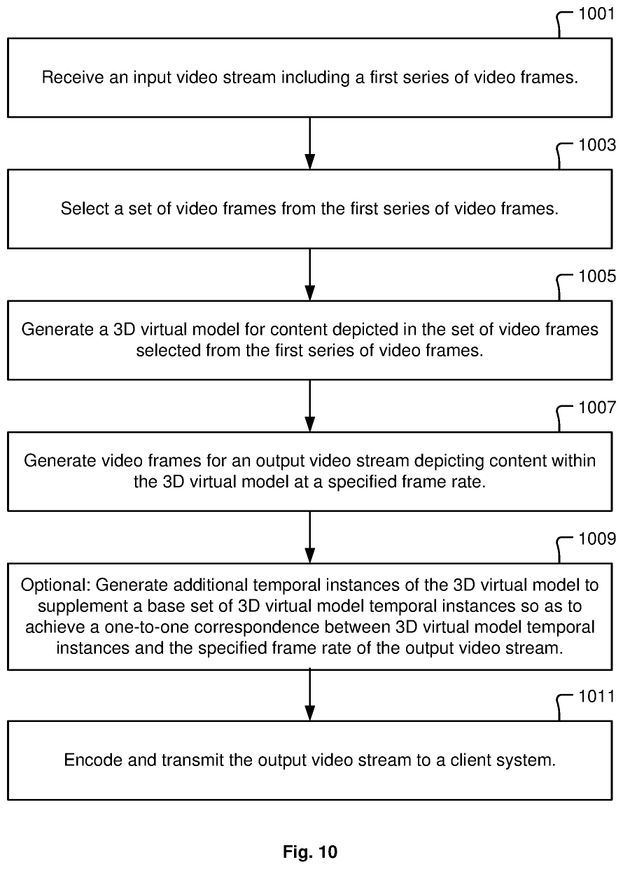

FIG. 10 shows a flowchart of a method for 3D conversion of a video stream, in accordance with some embodiments. The method includes an operation 1001 for receiving the input video stream 125 including a first series of video frames 2Df1, 2Df2, 2Df3, etc. In some embodiments, the first series of video frames 2Df1, 2Df2, 2Df3, etc., are generated by a camera. In some embodiments, the first series of video frames 2Df1, 2Df2, 2Df3, etc., depict a live event. In some embodiments, the live event is a livestreaming of a person playing a video game.

The method also includes an operation 1003 for selecting a set of video frames from the first series of video frames 2Df1, 2Df2, 2Df3, etc. In some embodiments, the method includes dynamically adjusting selection of the video frames from the first series of video frames 2Df1, 2Df2, 2Df3, etc., as a function of time. In some embodiments, dynamically adjusting selection of the video frames from the first series of video frames 2Df1, 2Df2, 2Df3, etc., as the function of time includes increasing a rate of video frame selection from the first series of video frames 2Df1, 2Df2, 2Df3, etc., in response to an increase in visual changes detected within the first series of video frames 2Df1, 2Df2, 2Df3, etc., over a first specified period of time. Also, in some embodiments, dynamically adjusting selection of the video frames from the first series of video frames 2Df1, 2Df2, 2Df3, etc., as the function of time includes decreasing the rate of video frame selection from the first series of video frames 2Df1, 2Df2, 2Df3, etc., in response to a decrease in visual changes detected within the first series of video frames 2Df1, 2Df2, 2Df3, etc., over a second specified period of time.

The method also includes an operation 1005 for generating the 3D virtual model 111-z for content depicted in the set of video frames selected from the first series of video frames 2Df1, 2Df2, 2Df3, etc. In some embodiments, the NeRF AI model implemented within the NeRF engine 107 is used to generate the 3D virtual model 111-z for content depicted in the selected video frames. The method also includes an operation 1007 for generating video frames 3Df1, 3Df2, 3Df3, etc., for the output video stream 137-z depicting content within the 3D virtual model 111-z at a specified frame rate. In some embodiments, generating the video frames 3Df1, 3Df2, 3Df3, etc., for the output video stream 137-z in operation 1007 includes executing the rendering engine 113 to generate a projection image of the 3D virtual model 111-z from a specified viewpoint within the 3D virtual model 111-z. In some embodiments, the method includes receiving the specified viewpoint within the 3D virtual model 111-z from the client computing system 135-z of the spectator 131-z. In some embodiments, the specified viewpoint is different than a viewpoint detected in the set of video frames selected from the first series of video frames 2Df1, 2Df2, 2Df3, etc. In some embodiments, the method also includes receiving a customization option specification from the client computing system 135-z of the spectator 131-z. Also, in some embodiments, the method includes applying the customization option specification in generating the 3D virtual model 111-z for content depicted in the set of video frames selected from the first series of video frames 2Df1, 2Df2, 2Df3, etc., of the input 2D video stream 125. In some embodiments, the customization option specification includes one or more of a background specification, a lighting specification, a contrast specification, a color specification, a subject matter theme specification, a contextual theme specification, an environmental specification, a special effect specification, a motion specification, an object specification, an object skin specification, an entity skin specification, and an in-game cosmetic specification.

In some embodiments, the set of video frames selected from the first series of video frames 2Df1, 2Df2, 2Df3, etc., is a subset of the first series of video frames 2Df1, 2Df2, 2Df3, etc. In some embodiments, the subset of the first series of video frames 2Df1, 2Df2, 2Df3, etc., are selected in accordance with a specified time frequency of occurrence within the first series of video frames 2Df1, 2Df2, 2Df3, etc. In some embodiments, generating the 3D virtual model 111-z in operation 1005 includes executing the NeRF AI model within the NeRF engine 107 to generate a base set of 3D virtual model 111-z temporal instances that includes a separate temporal instance of the 3D virtual model 111-z for each of the video frames in the subset of the first series of video frames 2Df1, 2Df2, 2Df3, etc. In some embodiments, the method includes an optional operation 1009 for generating additional temporal instances of the 3D virtual model 111-z to supplement the base set of 3D virtual model 111-z temporal instances so as to achieve a one-to-one correspondence between 3D virtual model 111-z temporal instances and the specified frame rate of the output video stream 137-z. In some embodiments, the NeRF AI model within the NeRF engine 107 is executed to generate the additional temporal instances of the 3D virtual model 111-z. In some embodiments, the specified frame rate of the output video stream 137-z is 60 frames per second.

The method also includes an operation 1011 for encoding and transmitting the output video stream 137-z to the client computing system 135-z of the z^{th} spectator 131-z. In some embodiments, the method includes encoding and transmitting the input video stream 125 to the client computing system 135-z of the z^{th} spectator 131-z in conjunction with the output video stream 137-z. Also, in some embodiments, the method includes receiving commentary from the client computing system 135-z of the z^{th} spectator 131-z, and conveying the commentary to a source of the input video stream 125. In some embodiments, the commentary includes a video clip taken from the output video stream 137-z as transmitted to the client computing system 135-z of the z^{th} spectator 131-z.

Many modern computer applications, such as video games, virtual reality applications, augmented reality applications, virtual world applications, etc., provide for various forms of live streaming to spectators of the computer applications. For ease of description, the term “video game” as used herein refers to any of the above-mentioned types of computer applications that provide for spectating of the execution of the computer application. Also, for ease of description, the term “player” (as in video game player) as used herein refers to a user that participates in the execution of any of the above-mentioned types of computer applications.

In various embodiments, in-game communications are made between different players of the video game. Also, in some embodiments, in-game communications are made between spectators of the video game and players of the video game. Also, in some embodiments, communications are made between virtual entities (e.g., video game-generated entities) and players of the video game. Also, in some embodiments, communications are made between spectators and virtual entities. Also, in some embodiments, communications are made between two or more spectators of the video game. The spectators of the video game in the various embodiments can be real people and/or virtual (e.g., AI-generated) spectators. Also, in some embodiments, a virtual spectator can be instantiated on behalf of a real person. In various embodiments, communications that are conveyed to players within the video game can have one or more of a textual format, an image format, a video format, an audio format, and a haptic format, among essentially any other format that can be implemented within the video game. In various embodiments, the content of a communication made within the video game is one or more of a gesture (made either by a real human body or a virtual entity within the video game), a spoken language statement/phrase (made either audibly or in written form), and a video game controller input. In various embodiments, the video game controller can be any type of device used to convey any type of user input to a computer system executing the video game. For example, in various embodiments, the video game controller is one or more of a hand-held video game controller, a head-mounted display (HMD) device, a sensor-embedded wearable device (e.g., glove, glasses, vest, shirt, pants, cape, hat, etc.), and a wielded control device (e.g., wand, club, gun, bow and arrow, sword, knife, bat, racket, shield, etc.).

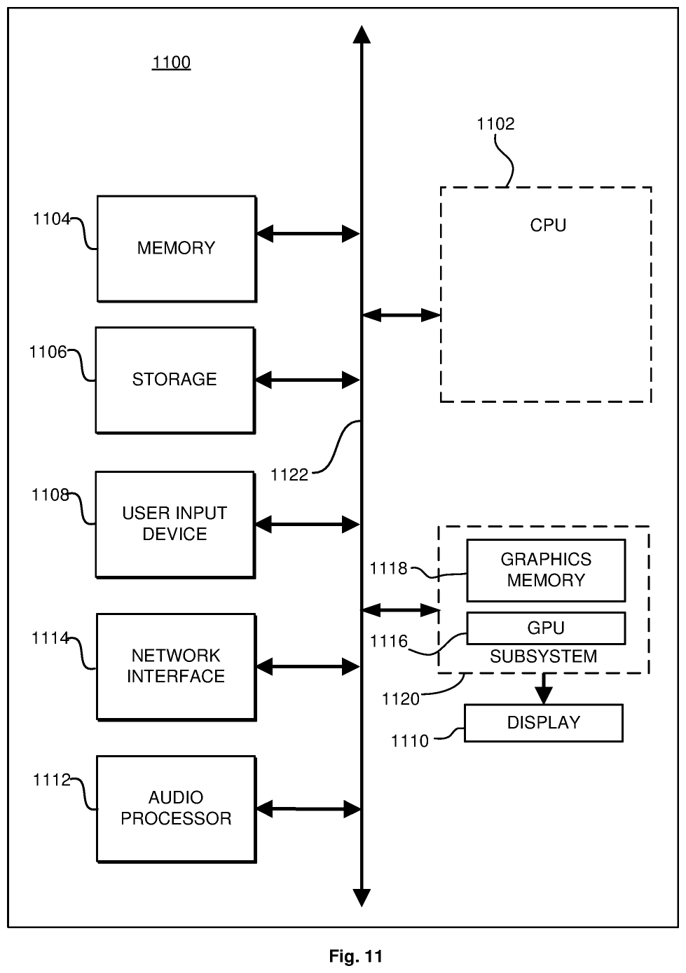

FIG. 11 shows various components of an example server device 1100 within a cloud-based computing system that can be used to perform aspects of the system 100 and method for 3D conversion of a video stream, in accordance with some embodiments. This block diagram illustrates the server device 1100 that can incorporate or can be a personal computer, video game console, personal digital assistant, a head mounted display (HMD), a wearable computing device, a laptop or desktop computing device, a server or any other digital computing device, suitable for practicing an embodiment of the disclosure. The server device (or simply referred to as “server” or “device”) 1100 includes a central processing unit (CPU) 1102 for running software applications and optionally an operating system. The CPU 1102 may be comprised of one or more homogeneous or heterogeneous processing cores. For example, the CPU 1102 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 1100 may be localized to a player playing a game segment (e.g., game console), or remote from the player (e.g., back-end server processor), or one of many servers using virtualization in the cloud-based gaming system 1100 for remote streaming of game play to client devices.

Memory 1104 stores applications and data for use by the CPU 1102. Storage 1106 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 1108 communicate user inputs from one or more users to device 1100, examples of which may include keyboards, mice, joysticks, touch pads, touch screens, still or video recorders/cameras, tracking devices for recognizing gestures, and/or microphones. Network interface 1114 allows device 1100 to communicate with other computer systems via an electronic communications network, and may include wired or wireless communication over local area networks and wide area networks such as the internet. An audio processor 1112 is adapted to generate analog or digital audio output from instructions and/or data provided by the CPU 1102, memory 1104, and/or storage 1106. The components of device 1100, including CPU 1102, memory 1104, data storage 1106, user input devices 1108, network interface 1114, and audio processor 1112 are connected via one or more data buses 1122.

A graphics subsystem 1120 is further connected with data bus 1122 and the components of the device 1100. The graphics subsystem 1120 includes a graphics processing unit (GPU) 1116 and graphics memory 1118. Graphics memory 1118 includes a display memory (e.g., a frame buffer) used for storing pixel data for each pixel of an output image. Graphics memory 1118 can be integrated in the same device as GPU 1116, connected as a separate device with GPU 1116, and/or implemented within memory 1104. Pixel data can be provided to graphics memory 1118 directly from the CPU 1102. Alternatively, CPU 1102 provides the GPU 1116 with data and/or instructions defining the desired output images, from which the GPU 1116 generates the pixel data of one or more output images. The data and/or instructions defining the desired output images can be stored in memory 1104 and/or graphics memory 1118. In an embodiment, the GPU 1116 includes 3D rendering capabilities for generating pixel data for output images from instructions and data defining the geometry, lighting, shading, texturing, motion, and/or camera parameters for a scene. The GPU 1116 can further include one or more programmable execution units capable of executing shader programs.

The graphics subsystem 1120 periodically outputs pixel data for an image from graphics memory 1118 to be displayed on display device 1110. Display device 1110 can be any device capable of displaying visual information in response to a signal from the device 1100, including CRT, LCD, plasma, and OLED displays. In addition to display device 1110, the pixel data can be projected onto a projection surface. Device 1100 can provide the display device 1110 with an analog or digital signal, for example.

Implementations of the present disclosure for 3D conversion of a video stream may be practiced using various computer device configurations including hand-held devices, microprocessor systems, microprocessor-based or programmable consumer electronics, minicomputers, mainframe computers, head-mounted display, wearable computing devices and the like. Embodiments of the present disclosure can also be practiced in distributed computing environments where tasks are performed by remote processing devices that are linked through a wire-based or wireless network.

In some embodiments, communication may be facilitated using wireless technologies. Such technologies may include, for example, 5G wireless communication technologies. 5G is the fifth generation of cellular network technology. 5G networks are digital cellular networks, in which the service area covered by providers is divided into small geographical areas called cells. Analog signals representing sounds and images are digitized in the telephone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a pool of frequencies that are reused in other cells. The local antennas are connected with the telephone network and the Internet by a high bandwidth optical fiber or wireless backhaul connection. As in other cell networks, a mobile device crossing from one cell to another is automatically transferred to the new cell. It should be understood that 5G networks are just an example type of communication network, and embodiments of the disclosure may utilize earlier generation wireless or wired communication, as well as later generation wired or wireless technologies that come after 5G.

With the above embodiments in mind, it should be understood that the disclosure can employ various computer-implemented operations involving data stored in computer systems. These operations are those requiring physical manipulation of physical quantities. Any of the operations described herein that form part of the disclosure are useful machine operations. The disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing.

One or more embodiments can also be fabricated as computer readable code (program instructions) on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

1. A system for three-dimensional conversion of a video stream, comprising:
an input processor configured to receive an input video stream including a first series of video frames;
a three-dimensional (3D) virtual model generator configured to select video frames from the input video stream and generate a 3D virtual model for content depicted in the selected video frames;
a frame generator configured to generate a second series of video frames for an output video stream depicting content within the 3D virtual model at a specified frame rate; and
an output processor configured to encode and transmit the output video stream to a client computing system.

2. The system as recited in claim 1, wherein the first series of video frames are generated by a camera.

3. The system as recited in claim 2, wherein the first series of video frames depict a live event.

4. The system as recited in claim 3, wherein the live event is a livestreaming of a person playing a video game.

5. The system as recited in claim 1, wherein the video frames selected from the first series of video frames by the 3D virtual model generator is a subset of the first series of video frames.

6. The system as recited in claim 5, wherein the subset of the first series of video frames includes video frames that correspond to a specified time frequency of occurrence within the first series of video frames.

7. The system as recited in claim 5, wherein the 3D virtual model generator is configured to implement a neural radiance field (NeRF) artificial intelligence (AI) model to generate a base set of 3D virtual model temporal instances that includes a separate temporal instance of the 3D virtual model for each of the video frames in the subset of the first series of video frames.

8. The system as recited in claim 7, wherein the 3D virtual model generator is configured to generate additional temporal instances of the 3D virtual model to supplement the base set of 3D virtual model temporal instances so as to achieve a one-to-one correspondence between 3D virtual model temporal instances and the specified frame rate of the output video stream.

9. The system as recited in claim 8, wherein the 3D virtual model generator is configured to implement the NeRF AI model to generate the additional temporal instances of the 3D virtual model.

10. The system as recited in claim 9, wherein the specified frame rate of the output video stream is 60 frames per second.

11. The system as recited in claim 1, wherein the 3D virtual model generator includes a frame selection engine configured to dynamically adjust selection of the video frames from the first series of video frames as a function of time.

12. The system as recited in claim 11, wherein the frame selection engine is configured to increase a rate of video frame selection from the first series of video frames in response to an increase in visual changes detected within the first series of video frames over a first specified period of time, and wherein the frame selection engine is configured to decrease the rate of video frame selection from the first series of video frames in response to a decrease in visual changes detected within the first series of video frames over a second specified period of time.

13. The system as recited in claim 1, wherein the 3D virtual model generator is configured to implement a neural radiance field (NeRF) artificial intelligence (AI) model in generating the 3D virtual model for content depicted in the selected video frames.

14. The system as recited in claim 1, wherein the frame generator is configured to implement a rendering engine that is configured to generate a projection image of the 3D virtual model from a specified viewpoint within the 3D virtual model.

15. The system as recited in claim 14, wherein the input processor is configured to receive the specified viewpoint from the client computing system and provide the specified viewpoint to the frame generator.

16. The system as recited in claim 14, wherein the specified viewpoint is different than a viewpoint depicted in the video frames selected from the first series of video frames by the 3D virtual model generator.

17. The system as recited in claim 1, wherein the input processor is configured to receive a customization option specification from the client computing system and provide the customization option specification to the 3D virtual model generator, and wherein the 3D virtual model generator is configured to apply the customization option specification in generating the 3D virtual model for content depicted in the selected video frames.

18. The system as recited in claim 17, wherein the customization option specification includes one or more of a background specification, a lighting specification, a contrast specification, a color specification, a subject matter theme specification, a contextual theme specification, an environmental specification, a special effect specification, a motion specification, an object specification, an object skin specification, an entity skin specification, and an in-game cosmetic specification.

19. The system as recited in claim 1, wherein the output processor is configured to encode and transmit the input video stream to the client computing system in conjunction with the output video stream.

20. The system as recited in claim 1, wherein the input processor is configured to receive commentary from the client computing system, and wherein the output processor is configured to convey the commentary to a source of the input video stream.
